(19) United States
(12) Patent Application Publication
(10) Pub. No.: US 2014/0229506 A1
(43) Pub. Date: Aug. 14, 2014

(54) DATA STREAM PROCESSING APPARATUS AND METHOD USING QUERY PARTITIONING

(71) Applicant: Electronics and Telecommunications Research Institute, Daejeon-city (KR)

(72) Inventor: Yong-Ju LEE, Daejeon (KR)

(73) Assignee: ELECTRONICS AND TELECOMMUNICATIONS RESEARCH INSTITUTE, Daejeon-city (KR)

(21) Appl. No.: 14/017,476

(22) Filed: Sep. 4, 2013

(30) Foreign Application Priority Data
Feb. 14, 2013 (KR) 10-2013-0015772

(51) Int. Cl. G06F 17/30

(52) U.S. Cl. CPC G06F 17/30451
USPC 707/774

(57) ABSTRACT

Disclosed herein is a data stream processing apparatus and method using query partitioning, which allow data stream processing apparatuses to perform partitioned processing/parallel processing on partitioned sub-queries. The proposed data stream processing apparatus using query partitioning receives a query from a user, partitions the query into a plurality of sub-queries, transmits the partitioned sub-queries to another data stream processing apparatus or a sub-query processing unit, integrates the results of the processing of sub-queries processed by the other data stream processing apparatus and the sub-query processing unit with each other, generates a response to the query, and transmits the generated response to the user.

### CROSS REFERENCE TO RELATED APPLICATION

This application claims the benefit of Korean Patent Application No. 10-2013-0015772 filed on Feb. 14, 2013, which is hereby incorporated by reference in its entirety into this application.

### BACKGROUND OF THE INVENTION

1. Technical Field

The present invention relates generally to data stream processing technology and, more particularly, to a data stream processing apparatus and method using query partitioning, which promptly and accurately provide the results of a query from a user in a big data environment in which the volume of data explosively increases and the generation velocity of the data also increases.

2. Description of the Related Art

Generally, a Database Management System (DBMS) is used to efficiently store and manage structured data and search for the structured data using a prompt query.

As shown in FIG. 1, a DBMS is generally configured to process a query requested by a user through a single central server. That is, a central server 11 previously stores data collected from data sources 14 in a storage unit 12. By means of this configuration, in response to a query request from each user 13, the central server 11 extracts the results of the query using the data stored in the storage unit 12, and replies the results of the query to the user 13.

A conventional DBMS basically processes statically stored data and is then capable of making a prompt and accurate response upon processing typical data.

However, recently, as big data having an enormous generation volume, many periods, and various formats (regular/irregular data) has appeared, a big data environment has emerged. Since big data is much larger than that of existing data, there is a problem in that the processing time required to collect, store, search and analyze data has increased and accurate results cannot be provided if only a DBMS is used. That is, a DBMS based on a conventional static central server management scheme is problematic in that when a large number of queries about a large amount of continuously varying data are processed, a load increases, thus making it difficult to make prompt responses to the queries.

Further, pieces of data dynamically generated every moment, such as sensor network data, real-time data from a manufacturing process, and social network service (SNS) data, exhibit the characteristics of continuously flowing through a network, without being statically stored.

In order to solve the problem of such a big data environment, a Data Stream Processing System (DSPS) has been used.

Generally, a DSPS is implemented as a single server and provides a response to the query of a user using dynamic data that is continuously flowing through a network. That is, as shown in FIG. 2, a DSPS managed via data streams is configured such that data having a data stream source format 23 is converted and managed into data having a data stream processing format 24 by a central server 21, and such that the central server 21 replies the results of a query using contained data at the moment of the query requested by a user 22. For example, Korean Patent Application Publication No. 10-2011-0055166 (entitled “Data stream processing apparatus and method using cluster query”) discloses technology in which a single server processes data streams to queries requested by a plurality of terminals.

Such a conventional data stream processing system is advantageous in that it is easy to process a large amount of data that is continuously varying, but it is problematic in that when a single server processes a large number of queries from a single data stream source, overhead occurs due to an explosively increasing large data volume and a high generation velocity as in the case of big data. That is, in order to efficiently process a large data volume, it is impossible for a single server to process the large data volume and it becomes difficult to promptly process data because the appearance/generation velocities of data rapidly increase.

### SUMMARY OF THE INVENTION

Accordingly, the present invention has been made keeping in mind the above problems occurring in the prior art, and an object of the present invention is to provide a data stream processing apparatus and method using query partitioning, which partition a query into a plurality of sub-queries and allow a plurality of data stream processing apparatuses to perform partitioned processing and parallel processing on the partitioned sub-queries, thus promptly and accurately providing the results of the processing of the query to a user.

In accordance with an aspect of the present invention to accomplish the above object, there is provided a data stream processing apparatus using query partitioning, including a query reception unit for receiving a query required to process a data stream from a user; a query partitioning unit for partitioning the query received from the query reception unit into a plurality of sub-queries; a sub-query transmission unit for transmitting at least one of the plurality of sub-queries to another data stream processing apparatus; a sub-query processing unit for processing a sub-query received from the sub-query transmission unit; a query integration unit for integrating results of sub-queries received from the other data stream processing apparatus and the sub-query processing unit and generating a response to the query; and a query response unit for transmitting the response received from the query integration unit to the user.

Preferably, the query reception unit may receive a sub-query from a further data stream processing apparatus and transmits the sub-query to the sub-query processing unit.

Preferably, the query partitioning unit may partition the received query into the plurality of sub-queries based on a query pattern, and transmit sub-queries including information about target apparatuses set depending on attributes of the sub-queries to the sub-query transmission unit.

Preferably, the sub-query transmission unit may transmit the sub-query to at least one of the other data stream processing apparatus and the sub-query processing unit based on information about target apparatuses included in the sub-queries received from the query partitioning unit.

Preferably, the sub-query transmission unit may transmit a sub-query to be processed thereby, among the plurality of sub-queries, to the sub-query processing unit.

Preferably, the sub-query processing unit may receive a sub-query, transmitted from the other data stream processing apparatus, through the query reception unit, and transmit results of the processing of the received sub-query to the query integration unit.

Preferably, the query integration unit may receive the results of the processing of the sub-query received from the other data stream processing apparatus through the sub-query processing unit and transmit the results of the processing of the sub-query to the other data stream processing apparatus.

Preferably, the data stream processing apparatus may further include a query management unit for receiving a query pattern including a type and a format of the query from the query response unit and managing the query pattern.

Preferably, the query management unit may detect a previously stored query pattern and transmits the query pattern to the query partitioning unit.

Preferably, the data stream processing apparatus may further include a query pattern storage unit for storing the query pattern including the type and the format of the query.

In accordance with another aspect of the present invention to accomplish the above object, there is provided a data stream processing method using query partitioning, including receiving, by a query reception unit, a query required to process a data stream from a user; partitioning, by a query partitioning unit, the received query into a plurality of sub-queries; transmitting, by a sub-query transmission unit, at least one of the plurality of sub-queries to another data stream processing apparatus; processing, by a sub-query processing unit, a sub-query received from the sub-query transmission unit; integrating, by a query integration unit, results of sub-queries received from the other data stream processing apparatus and the sub-query processing unit and generating a response to the query; and transmitting, by a query response unit, the generated response to the user.

Preferably, the data stream processing method may further include receiving, by the query reception unit, a sub-query from a further data stream processing apparatus.

Preferably, the data stream processing method may further include processing, by the sub-query processing unit, the sub-query received from the further data stream processing apparatus.

Preferably, partitioning into the sub-queries may include partitioning, by the query partitioning unit, the query into the plurality of sub-queries; setting, by the query partitioning unit, target apparatuses depending on attributes of the sub-queries; and generating, by the query partitioning unit, sub-queries including information about the set target apparatuses.

Preferably, partitioning into the sub-queries may include detecting, by the query management unit, a previously stored query pattern; and partitioning, by the query partitioning unit, the query into a plurality of sub-queries based on the detected query pattern.

Preferably, transmitting to the other data stream processing apparatus may be configured such that the sub-query transmission unit transmits the sub-query to the other data stream processing apparatus based on information about target apparatuses included in the plurality of sub-queries.

Preferably, the data stream processing method may further include transmitting, by the sub-query transmission unit, the sub-query to the sub-query processing unit based on information about target apparatuses included in the plurality of sub-queries.

Preferably, the data stream processing method may further include transmitting, by the query integration unit, results of processing of the sub-query received from the other data stream processing apparatus to the other data stream processing apparatus.

Preferably, the data stream processing method may further include detecting, by the query response unit, a query pattern including a type and a format of the query.

Preferably, the data stream processing method may further include receiving, by a query management unit, the query pattern including the type and the format of the query detected at detecting the query pattern, and storing the query pattern in a query pattern storage unit.

In accordance with the present invention, the data stream processing apparatus and method using query partitioning are advantageous in that, in order to process the data streams, they accommodate data streams via multiplexing/distributed processing and partition a query requested by a user into sub-queries, so that a plurality of data stream processing apparatuses partition and execute the sub-queries in parallel, thus greatly reducing a response time to the query of the user in an environment in which a data volume explosively increases and a data generation velocity increases, and so that capability to accommodate a large amount of data is improved, thus providing more accurate query results.

Further, the data stream processing apparatus and method using query partitioning are advantageous in that query patterns including types/formats of processed queries are stored so as to search for a pattern efficient for a subsequent query, and are fed back upon partitioning each query, thus enabling effective query partitioning to be performed by means of learning of the query patterns.

Furthermore, the data stream processing apparatus and method using query partitioning are advantageous in that the parallelism of query processing is guaranteed while a single query is partitioned into a plurality of sub-queries, thus improving the velocity of partitioned processing of queries.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are diagrams showing a conventional database management system;

FIG. 3 is a diagram showing an example of a data stream processing system configured to include data stream processing apparatuses using query partitioning according to an embodiment of the present invention;

FIG. 4 is a diagram showing query processing performed by the data stream processing system configured to include data stream processing apparatuses using query partitioning according to an embodiment of the present invention;

FIG. 5 is a block diagram showing the configuration of a data stream processing apparatus using query partitioning according to an embodiment of the present invention;

FIGS. 6 and 7 are flowcharts showing a data stream processing method using query partitioning according to an embodiment of the present invention; and

FIG. 8 is a flowchart showing an example of a data stream processing method using query partitioning according to an embodiment of the present invention.

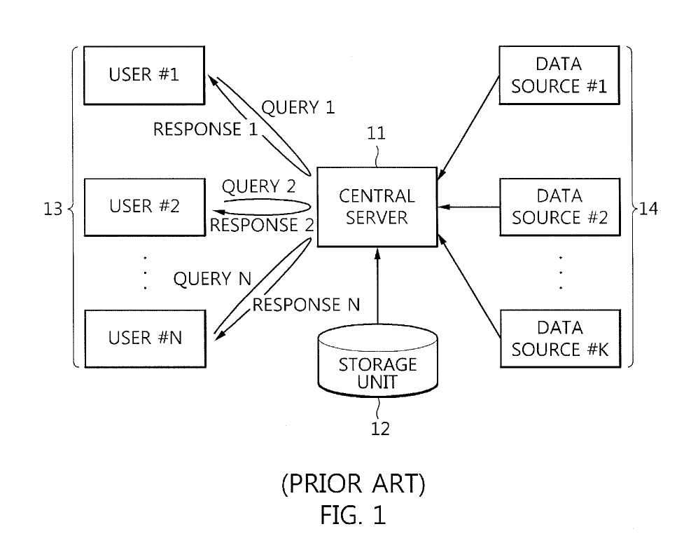

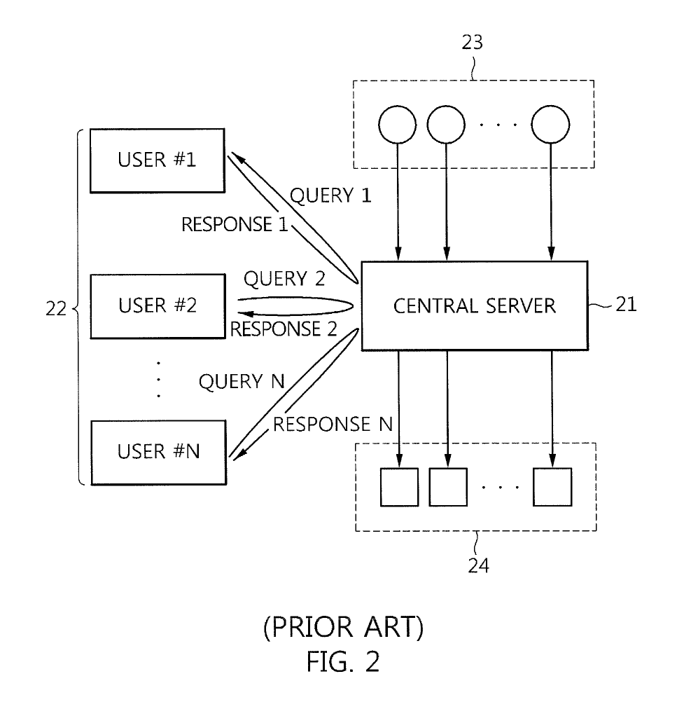

### DESCRIPTION OF THE PREFERRED EMBODIMENTS

Hereinafter, preferred embodiments of the present invention will be described in detail with reference to the attached drawings so as to describe in detail the present invention to such an extent that those skilled in the art can easily implement the technical spirit of the present invention. Reference now should be made to the drawings, in which the same reference numerals are used throughout the different drawings to designate the same or similar components. In the following description, detailed descriptions of related known elements or functions that may unnecessarily make the gist of the present invention obscure will be omitted.

Hereinafter, a data stream processing apparatus using query partitioning according to an embodiment of the present invention will be described in detail with reference to the attached drawings.

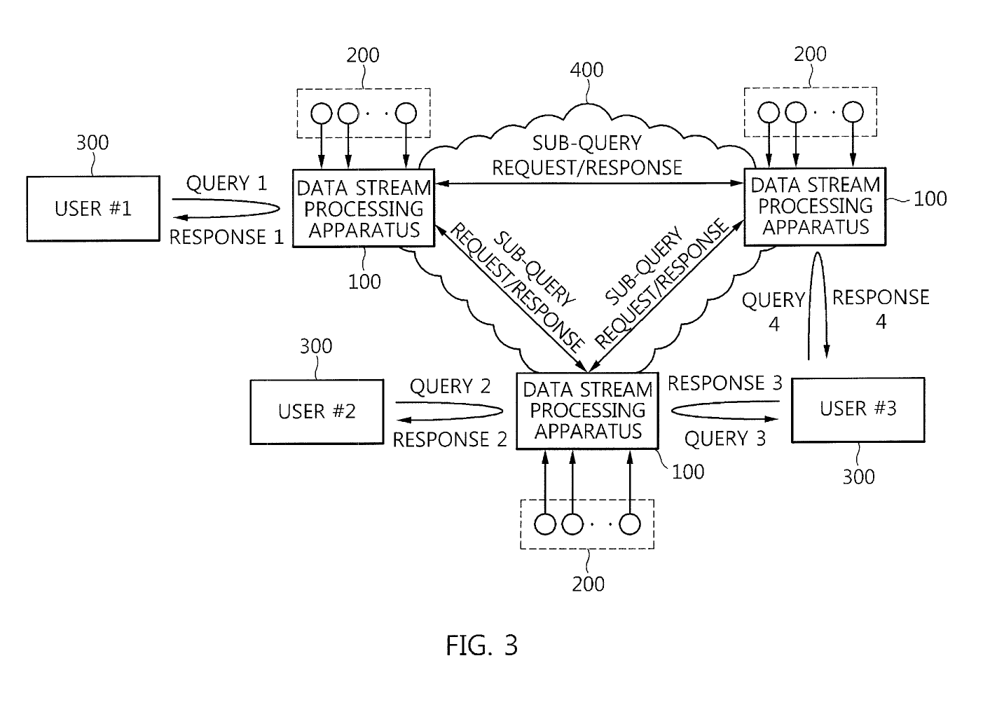

FIG. 3 is a diagram showing an example of a data stream processing system configured to include data stream processing apparatuses using query partitioning according to an embodiment of the present invention.

As shown in FIG. 3, the data stream processing system includes a plurality of data stream processing apparatuses using query partitioning (hereinafter referred to as “data stream processing apparatuses 100”).

The data stream processing system is configured such that each of the plurality of data stream processing apparatuses 100 individually partitions and receives a distributed data stream source 200.

The data stream processing apparatuses 100 exchange sub-queries obtained by partitioning a query requested by a user 300 with each other. In this case, the data stream processing apparatuses 100 are configured to process sub-queries having different attributes, and transmit the sub-queries to the data stream processing apparatuses 100 suitable for the respective attributes of the partitioned sub-queries.

Each data stream processing apparatus 100 transmits the results of the processing of a received sub-query to the corresponding data stream processing apparatus 100 that transmitted the sub-query. Each data stream processing apparatus 100 integrates the results of the processing of sub-queries received from other data stream processing apparatuses 100, generates final query results, and transmits the final query results to the user 300.

In FIG. 3, although data stream processing apparatuses are shown as being configured using three data stream processing apparatuses 100, the number of data stream processing apparatuses is not limited, and two or more data stream processing apparatuses may be configured.

After performing the processing of the query, the data stream processing apparatus 100 stores the sub-queries of the processed query and the results of the sub-queries in conjunction with a data stream processing apparatus 100 which requested the results of the sub-queries and data stream processing apparatuses 100 which executed the corresponding sub-queries. Accordingly, after a single query has been executed, sub-queries are stored in at least two data stream processing apparatuses 100, and a network for the requests/responses of sub-queries is virtually configured, and then a sub-query sharing network 400 is formed. In this case, as the number of queries that are processed increases, sub-queries and the results of the sub-queries are distributed over the sub-query sharing network. Accordingly, sub-queries that are frequently made are shared by all of a plurality of data stream processing apparatuses, thus enabling fast processing thanks to a caching effect when sub-queries are processed.

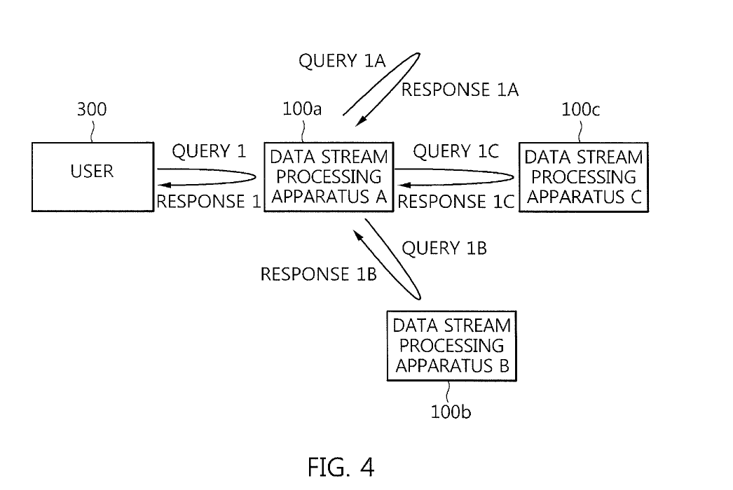

FIG. 4 is a diagram showing query processing performed by the data stream processing system configured to include data stream processing apparatuses using query partitioning according to an embodiment of the present invention. Here, the number of sub-queries obtained from partitioning and the number of data stream processing apparatuses including the sub-queries are not limited to examples shown in the drawing. FIG. 4 illustrates a configuration in which a single query is partitioned into sub-queries, and a plurality of servers process the partitioned sub-queries and return the processed results to a server which requested the query, and then the corresponding operation is performed. Such a configuration is not limited to a specific example.

As shown in FIG. 4, the data stream processing system is assumed to include a data stream processing apparatus A 100a, a data stream processing apparatus B 100b, and a data stream processing apparatus C 100c.

When a user 300 requests query 1 from the data stream processing apparatus A 100a, the data stream processing apparatus A 100a partitions the received query 1 into three sub-queries (that is, query 1a, query 1b, and query 1c).

The data stream processing apparatus A 100a transmits the sub-queries to the corresponding data stream processing apparatuses 100 depending on the attributes of the partitioned sub-queries. That is, since query 1a corresponds to the attribute of the data stream processing apparatus A 100a, it is executed by the data stream processing apparatus A 100a, and as a result of the query, response 1a is derived.

Since query 1b corresponds to the attribute of the data stream processing apparatus B 100b, it is transmitted to the data stream processing apparatus B 100b. As a result, the data stream processing apparatus B 100b executes the received query 1b, and transmits response 1b indicating the results of the query 1b to the data stream processing apparatus A 100a.

Since query 1c corresponds to the attribute of the data stream processing apparatus C 100c, it is transmitted to the data stream processing apparatus C 100c. Accordingly, the data stream processing apparatus C 100c executes the received query 1c, and transmits response 1c indicating the results of the query 1c to the data stream processing apparatus A 100a.

The data stream processing apparatus A 100a integrates the response 1a, the response 1b, and the response 1c, generates response 1 indicating the results of the processing of the query 1, and provides the response 1 to the user 300.

Here, the data stream processing apparatus A 100a that received the request from the user may not newly perform the processing of the query 1a when the results of query 1a are identical to those of a previously requested sub-query.

For example, when response 1 indicating the results of previously processed query 1 is stored, the data stream processing apparatus A 100a detects the stored response 1 and provides the response 1 to the user 300.

As another example, when only response 1a indicating the results of sub-query 1a, which is the sub-query of the previously processed query 1, is stored, the data stream processing apparatus A 100a requests the data stream processing apparatus B 100b and the data stream processing apparatus C 100c to transmit the results of the sub-query 1b and sub-query 1c. Accordingly, the data stream processing apparatus B 100b and the data stream processing apparatus C 100c detect previously stored response 1b (that is, the results of sub-query 1b) and previously stored response 1c (that is, the results of sub-query 1c) and transmit the responses 1b and 1c to the data stream processing apparatus A 100a. The data stream processing apparatus A 100a integrates the previously stored response 1a and the received responses 1b and 1c, generates response 1 indicating the processing results of the query 1, and provides the response 1 to the user 300.

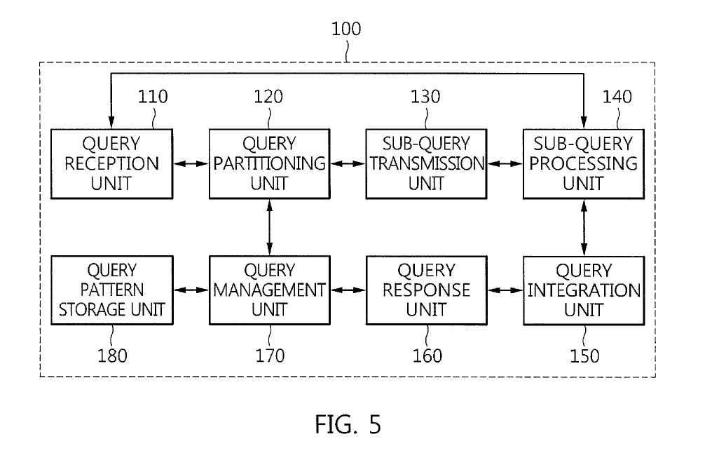

FIG. 5 is a block diagram showing the configuration of a data stream processing apparatus using query partitioning according to an embodiment of the present invention.

As shown in FIG. 5, a data stream processing apparatus 100 includes a query reception unit 110, a query partitioning unit 120, a sub-query transmission unit 130, a sub-query processing unit 140, a query integration unit 150, a query response unit 160, a query management unit 170, and a query pattern storage unit 180.

The query reception unit 110 receives a query from a user 300. That is, the query reception unit 110 receives a query required to request processing using a distributed data stream source 200 from the user 300. The query reception unit 110 transmits the received query to the query partitioning unit 120.

The query reception unit 110 receives a sub-query from another data stream processing apparatus 100. That is, the query reception unit 110 receives a sub-query required for partitioned processing using the distributed data stream source 200 from the other data stream processing apparatus 100. The query reception unit 110 transmits the received sub-query to the sub-query processing unit 140.

When the query is received from the query reception unit 110, the query partitioning unit 120 establishes a plan to execute the query. The query partitioning unit 120 partitions the received query into a plurality of sub-queries based on the query execution plan and previously stored query patterns. That is, the query partitioning unit 120 partitions the received query into the plurality of sub-queries depending on attributes. For this, the query partitioning unit 120 requests the query management unit 170 to transmit query patterns. The query partitioning unit 120 partitions the query into a plurality of sub-queries based on the query patterns received from the query management unit 170. In this case, the query partitioning unit 120 sets target apparatuses (that is, one of a plurality of data stream processing apparatuses 100 included in the data stream processing system) depending on the attributes of the sub-queries. The query partitioning unit 120 transmits sub-queries including information about the set target apparatuses to the sub-query transmission unit 130.

The sub-query transmission unit 130 transmits the plurality of sub-queries received from the query partitioning unit 120 to the corresponding data stream processing apparatuses 100. That is, the sub-query transmission unit 130 detects target apparatuses from the received sub-queries. The sub-query transmission unit 130 transmits the received sub-queries to the detected target apparatuses. In this case, when a target apparatus is the sub-query transmission unit itself (that is, when the target apparatus is the data stream processing apparatus 100 that received the query), the sub-query transmission unit 130 transmits the corresponding sub-query to the sub-query processing unit 140.

The sub-query processing unit 140 processes the received sub-query. That is, the sub-query processing unit 140 executes the sub-query received from the query reception unit 110 or the sub-query transmission unit 130. In this case, the sub-query processing unit 140 executes the sub-query using the distributed data stream source 200. The sub-query processing unit 140 transmits the results of the processing of the sub-query to the query integration unit 150.

The query integration unit 150 integrates the results of the processing of the sub-query received from the sub-query processing unit 140 and the results of the processing of sub-queries received from other data stream processing apparatuses 100 and then generates a response to the query received from the user 300. The query integration unit 150 transmits the generated response to the query response unit 160.

The query integration unit 150 transmits the results of the processing of sub-queries, received from the sub-query processing unit 140 and the other data stream processing apparatuses 100, to the corresponding data stream processing apparatus 100. That is, the query integration unit 150 transmits the results of the processing of sub-queries received from other data stream processing apparatuses 100 through the query reception unit 110 to the query integration unit 150 of the corresponding data stream processing apparatus 100.

The query response unit 160 transmits the response received from the query integration unit 150 to the user 300. That is, the query response unit 160 receives the response indicating the results of the processing of the query of the user 300 from the query integration unit 150 and provides the response to the user 300. The query response unit 160 transmits a query pattern including the type and format of the query to the query management unit 170.

The query management unit 170 stores the query pattern received from the query response unit 160 in the query pattern storage unit 180 and then manages the query pattern. The query management unit 170 detects the query pattern stored in the query pattern storage unit 180 in response to a request from the query partitioning unit 120, and transmits the detected query pattern to the query partitioning unit 120.

The query pattern storage unit 180 stores the query pattern transmitted from the query management unit 170. That is, the query pattern storage unit 180 stores query patterns including the types and formats of respective queries.

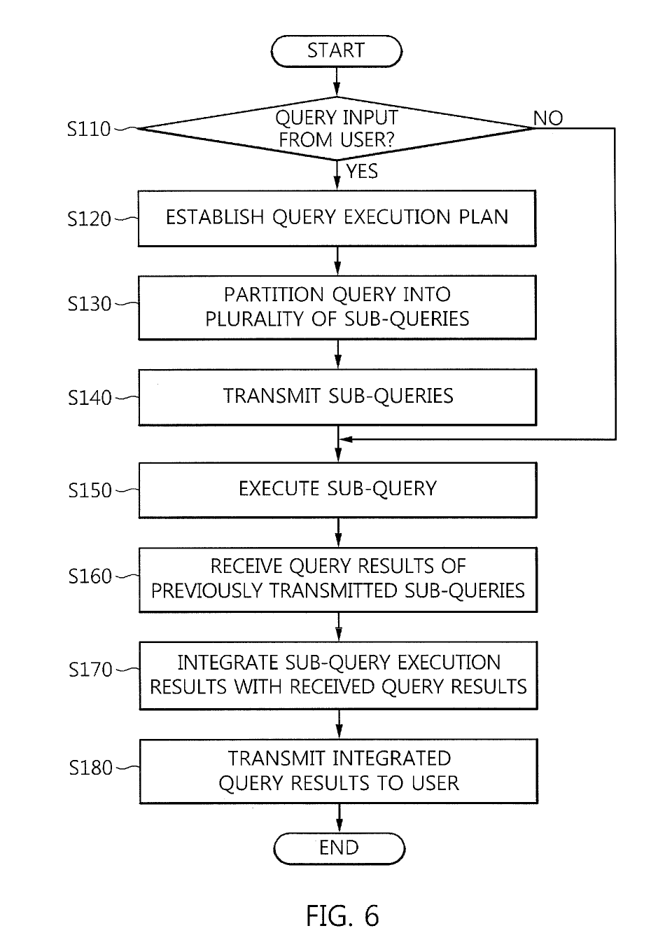

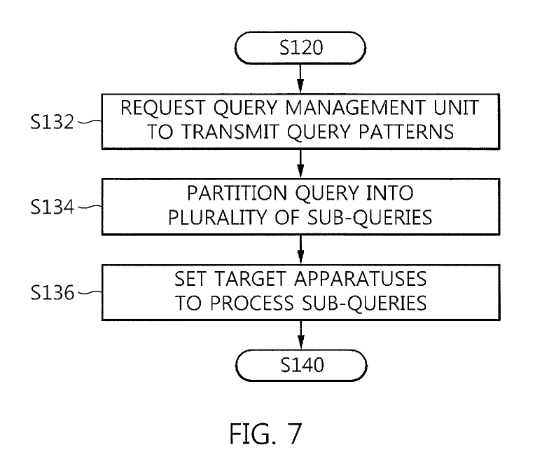

Hereinafter, a data stream processing method using query partitioning according to embodiments of the present invention will be described in detail with reference to the attached drawings. FIGS. 6 and 7 are flowcharts showing a data stream processing method using query partitioning according to an embodiment of the present invention.

The query reception unit 110 receives a query from a user 300 or another data stream processing apparatus 100. That is, the query reception unit 110 receives a query from the user 300 or a sub-query from another data stream processing apparatus 100.

When the received query is a query input from the user 300 (in case of “Yes” at step S110), the query reception unit 110 transmits the received query to the query partitioning unit 120. In this case, when a sub-query is received from another data stream processing apparatus 100, the query reception unit 110 transmits the received sub-query to the sub-query processing unit 140.

The query partitioning unit 120 establishes a plan to execute the query at step S120, and partitions the received query into a plurality of sub-queries based on the established query execution plan and query patterns stored in the query pattern storage unit 180 at step S130. This will be described in detail below with reference to FIG. 7.

The query partitioning unit 120 requests the query management unit 170 to transmit query patterns at step S132. Accordingly, the query management unit 170 detects the query patterns stored in the query pattern storage unit 180 and transmits the query patterns to the query partitioning unit 120.

The query partitioning unit 120 partitions the query into the plurality of sub-queries based on the query patterns received from the query management unit 170 and the query execution plan at step S134.

The query partitioning unit 120 sets target apparatuses depending on the respective attributes of the previously partitioned sub-queries at step S136. The query partitioning unit 120 transmits sub-queries including information about the set target apparatuses to the sub-query transmission unit 130.

The sub-query transmission unit 130 transmits the sub-queries received from the query partitioning unit 120 at step S140. That is, the sub-query transmission unit 130 detects the target apparatuses from the received sub-queries. The sub-query transmission unit 130 transmits the received sub-queries to the detected target apparatuses. In this case, when a target apparatus is the sub-query transmission unit itself (that is, the data stream processing apparatus 100 that received the query), the sub-query transmission unit 130 transmits the corresponding sub-query to the sub-query processing unit 140.

The sub-query processing unit 140 executes the sub-query received from another data stream processing apparatus 100 or from the sub-query transmission unit 130 at step S150. In this case, the sub-query processing unit 140 executes the sub-query using the distributed data stream source 200. The sub-query processing unit 140 transmits the results of the processing of the sub-query to the query integration unit 150.

The query integration unit 150 receives the results of the processing of the previously transmitted sub-queries from other data stream processing apparatuses 100 at step S160. That is, the query integration unit 150 receives the results of the processing of the sub-queries transmitted by the sub-query transmission unit 130 from the corresponding data stream processing apparatuses 100.

The query integration unit 150 integrates the results of the processing of the sub-query from the sub-query processing unit 140 with the previously stored results of the processing of the sub-queries at step S170. That is, the query integration unit 150 integrates the results of the processing of the sub-query received from the sub-query processing unit 140 with the results of the processing of the sub-queries received from the other data stream processing apparatuses 100 and generates a response to the query received from the user 300. The query integration unit 150 transmits the generated response to the query response unit 160. In this case, the query integration unit 150 transmits the results of the processing of the sub-queries, received from the sub-query processing unit 140 and the other data stream processing apparatuses 100, to the corresponding data stream processing apparatuses 100. That is, the query integration unit 150 transmits the results of the processing of the sub-queries, received from the other data stream processing apparatuses 100 through the query reception unit 110, to the query integration unit 150 of the corresponding data stream processing apparatus 100.

The query response unit 160 transmits the results of the queries integrated by the query integration unit 150 to the user 300 at step S180. That is, the query response unit 160 receives a response, indicating the results of the processing of the query of the user 300, from the query integration unit 150, and provides the response to the user 300. In this case, the query response unit 160 transmits a query pattern including the type and format of the query to the query management unit 170. Accordingly, the query management unit 170 stores the query pattern received from the query response unit 160 in the query pattern storage unit 180 and manages the query pattern.

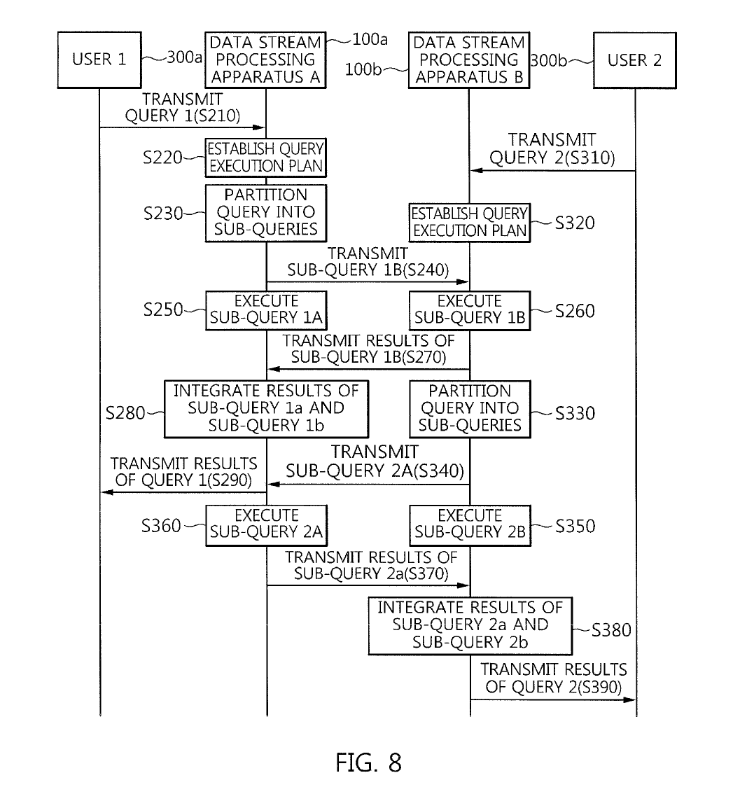

Hereinafter, an example of a data stream processing method using query partitioning according to an embodiment of the present invention will be described in detail with reference to the attached drawings. FIG. 8 is a flowchart showing an example of a data stream processing method using query partitioning according to an embodiment of the present invention. Below, a data stream processing system is assumed to include two data stream processing apparatuses, that is, data stream processing apparatus A 100a and B 100b.

When query 1 is transmitted from a user 1 300a to the data stream processing apparatus A 100a at step S210, the data stream processing apparatus A 100a establishes a plan to execute the query at step S220, and partitions the query 1 into sub-queries at step S230. In this case, the data stream processing apparatus A 100a partitions the query 1 into two sub-queries (that is, sub-query 1a and sub-query 1b).

The data stream processing apparatus A 100a transmits the sub-query 1b to be processed by the data stream processing apparatus B 100b, of the sub-queries obtained from partitioning, to the data stream processing apparatus B 100b at step S240.

The data stream processing apparatus A 100a executes the sub-query 1a to be processed thereby at step S250, and the data stream processing apparatus B 100b executes the received sub-query 1b at step S260.

The data stream processing apparatus B 100b transmits the results of the execution of the sub-query 1b to the data stream processing apparatus A 100a at step S270.

The data stream processing apparatus A 100a integrates the results of the execution of the sub-query 1b received from the data stream processing apparatus B 100b with the results of the execution of the sub-query 1a processed by the data stream processing apparatus A 100a at step S280. The data stream processing apparatus A 100a transmits response 1, which indicates the results of the query 1 generated by integrating the sub-query 1a with the sub-query 1b, to the user 300a at step S290.

When query 2 is transmitted from user 2 300b to the data stream processing apparatus B 100b at step S310, the data stream processing apparatus B 100b establishes a plan to execute the query at step S320, and partitions the query 2 into sub-queries at step S330. In this case, the data stream processing apparatus B 100b partitions the query 2 into two sub-queries (that is, sub-query 2a and sub-query 2b).

The data stream processing apparatus B 100b transmits the sub-query 2a to be processed by the data stream processing apparatus A 100a, of the partitioned sub-queries, to the data stream processing apparatus A 100a at step S340.

The data stream processing apparatus B 100b executes the sub-query 2b to be processed thereby at step S350, and the data stream processing apparatus A 100a executes the sub-query 2a at step S360.

The data stream processing apparatus A 100a transmits the results of the execution of the sub-query 2a to the data stream processing apparatus B 100b at step S370.

The data stream processing apparatus B 100b integrates the results of the execution of the sub-query 2a received from the data stream processing apparatus A 100a with the results of the execution of the sub-query 2b processed by the apparatus B 100b at step S380. The data stream processing apparatus B 100b transmits response 2, which indicates the results of the query 2 generated by integrating the sub-query 2a with the sub-query 2b, to the user 2 300b at step S390.

As described above, the data stream processing apparatus 100 and method using query partitioning are advantageous in that, in order to process the data streams, they accommodate data streams via multiplexing/distributed processing and partition a query requested by the user 300 into sub-queries, so that a plurality of data stream processing apparatuses 100 partition and execute the sub-queries in parallel, thus greatly reducing a response time to the query of the user 300 in an environment in which a data volume explosively increases and a data generation velocity increases, and so that capability to accommodate a large amount of data is improved, thus providing more accurate query results.

Further, the data stream processing apparatus 100 and method using query partitioning are advantageous in that query patterns including types/formats of processed queries are stored so as to search for a pattern efficient for a subsequent query, and are fed back upon partitioning each query, thus enabling effective query partitioning to be performed by means of learning of the query patterns.

Furthermore, the data stream processing apparatus 100 and method using query partitioning are advantageous in that the parallelism of query processing is guaranteed while a single query is partitioned into a plurality of sub-queries, thus improving the velocity of partitioned processing of queries.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data stream processing apparatus using query partitioning, comprising:
a query reception unit for receiving a query required to process a data stream from a user;
a query partitioning unit for partitioning the query received from the query reception unit into a plurality of sub-queries;
a sub-query transmission unit for transmitting at least one of the plurality of sub-queries to another data stream processing apparatus;
a sub-query processing unit for processing a sub-query received from the sub-query transmission unit;
a query integration unit for integrating results of sub-queries received from the other data stream processing apparatus and the sub-query processing unit and generating a response to the query; and
a query response unit for transmitting the response received from the query integration unit to the user.

2. The data stream processing apparatus of claim 1, wherein the query reception unit receives a sub-query from a further data stream processing apparatus and transmits the sub-query to the sub-query processing unit.

3. The data stream processing apparatus of claim 1, wherein the query partitioning unit partitions the received query into the plurality of sub-queries based on a query pattern, and transmits sub-queries including information about target apparatuses set depending on attributes of the sub-queries to the sub-query transmission unit.

4. The data stream processing apparatus of claim 1, wherein the sub-query transmission unit transmits the sub-query to at least one of the other data stream processing apparatus and the sub-query processing unit based on information about target apparatuses included in the sub-queries received from the query partitioning unit.

5. The data stream processing apparatus of claim 1, wherein the sub-query transmission unit transmits a sub-query to be processed thereby, among the plurality of sub-queries, to the sub-query processing unit.

6. The data stream processing apparatus of claim 1, wherein the sub-query processing unit receives a sub-query, transmitted from the other data stream processing apparatus, through the query reception unit, and transmits results of the processing of the received sub-query to the query integration unit.

7. The data stream processing apparatus of claim 1, wherein the query integration unit receives the results of the processing of the sub-query received from the other data stream processing apparatus through the sub-query processing unit and transmits the results of the processing of the sub-query to the other data stream processing apparatus.

8. The data stream processing apparatus of claim 1, further comprising a query management unit for receiving a query pattern including a type and a format of the query from the query response unit and managing the query pattern.

9. The data stream processing apparatus of claim 8, wherein the query management unit detects a previously stored query pattern and transmits the query pattern to the query partitioning unit.

10. The data stream processing apparatus of claim 8, further comprising a query pattern storage unit for storing the query pattern including the type and the format of the query.

11. A data stream processing method using query partitioning, comprising:
receiving, by a query reception unit, a query required to process a data stream from a user;
partitioning, by a query partitioning unit, the received query into a plurality of sub-queries;
transmitting, by a sub-query transmission unit, at least one of the plurality of sub-queries to another data stream processing apparatus;
processing, by a sub-query processing unit, a sub-query received from the sub-query transmission unit;
integrating, by a query integration unit, results of sub-queries received from the other data stream processing apparatus and the sub-query processing unit and generating a response to the query; and
transmitting, by a query response unit, the generated response to the user.

12. The data stream processing method of claim 11, further comprising receiving, by the query reception unit, a sub-query from a further data stream processing apparatus.

13. The data stream processing method of claim 12, further comprising processing, by the sub-query processing unit, the sub-query received from the further data stream processing apparatus.

14. The data stream processing method of claim 11, wherein partitioning into the sub-queries comprises:
partitioning, by the query partitioning unit, the query into the plurality of sub-queries;
setting, by the query partitioning unit, target apparatuses depending on attributes of the sub-queries; and
generating, by the query partitioning unit, sub-queries including information about the set target apparatuses.

15. The data stream processing method of claim 11, wherein partitioning into the sub-queries comprises:
detecting, by the query management unit, a previously stored query pattern; and
partitioning, by the query partitioning unit, the query into a plurality of sub-queries based on the detected query pattern.

16. The data stream processing method of claim 11, wherein transmitting to the other data stream processing apparatus is configured such that the sub-query transmission unit transmits the sub-query to the other data stream processing apparatus based on information about target apparatuses included in the plurality of sub-queries.

17. The data stream processing method of claim 11, further comprising transmitting, by the sub-query transmission unit, the sub-query to the sub-query processing unit based on information about target apparatuses included in the plurality of sub-queries.

18. The data stream processing method of claim 11, further comprising transmitting, by the query integration unit, results of processing of the sub-query received from the other data stream processing apparatus to the other data stream processing apparatus.

19. The data stream processing method of claim 11, further comprising detecting, by the query response unit, a query pattern including a type and a format of the query.

20. The data stream processing method of claim 19, further comprising receiving, by a query management unit, the query pattern including the type and the format of the query detected at detecting the query pattern, and storing the query pattern in a query pattern storage unit.
